(19) United States
(12) Patent Application Publication
(10) Pub. No.: US 2016/0261708 A1
(43) Pub. Date: Sep. 8, 2016

(54) ONGOING MANAGEMENT OF SHAPED ONLINE REPUTATION

(71) Applicant: Microsoft Technology Licensing, LLC, Redmond, WA (US)

(72) Inventors: Rajmohan Rajagopalan, Sammamish, WA (US); Michael Stokes, Redmond, WA (US); Carolyn Sparling, Lynnwood, WA (US)

(21) Appl. No.: 14/723,885

(22) Filed: May 28, 2015

Related U.S. Application Data
(60) Provisional application No. 62/129,600, filed on Mar. 6, 2015.

(51) Int. Cl. H04L 29/08; H04L 12/26

(52) U.S. Cl. CPC H04L 67/306; H04L 43/06; G06Q 50/01

(57) ABSTRACT

Ongoing management of a shaped online reputation is provided. A service such as a reputation management service monitors digital assets of a reputation owner hosted by external resources based on a reputation profile. The reputation profile is configured by a reputation manager. A change to the digital assets is detected. In response, the change and the reputation profile are processed to match suggested actions with operations to shape the online profile. A description of the suggested actions, the reputation profile, and the change are transmitted to the reputation manager to prompt the reputation manager to customize or confirm the reputation profile and the suggested actions. The suggested actions are executed to shape the online reputation in response to a confirmation to the transmission by the reputation manager.

### CROSS-REFERENCE TO RELATED APPLICATION

This application claims priority under 35 U.S.C. §119(e) to U.S. Provisional Patent Application Ser. No. 62/129,600 filed on Mar. 6, 2015. The disclosure of the U.S. Provisional patent application is hereby incorporated by reference in its entirety.

### BACKGROUND

The proliferation of computerized automation of processes in every aspect of life, data storage and processing have become a major component of networked systems handling social interactions. In such systems, social data is entered, modified, or deleted from a number of sources. Various social data stores from simple tables to complicated databases are maintained and synchronized as new entries or modifications are made by different sources. In addition, variety of services are offered to enable internal and external parties' interactivity with the social data hosted by the data stores. Continued maintenance of a reputation of an online subscriber present significant challenges in management and disposition of the social data.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to ongoing management of a shaped online reputation. In some example embodiments, a reputation management service may monitor digital assets of a reputation owner hosted by external resources based on a reputation profile. The reputation profile may be configured by a reputation manager. A change to the digital assets and the reputation profile may be processed to match suggested actions in response to a detection of the change. A description of the suggested actions, the reputation profile, and the change may be transmitted to the reputation manager to prompt the reputation manager to customize or confirm the reputation profile and the suggested actions. The suggested actions may be executed to shape the online reputation in response to a confirmation of the transmission by the reputation manager.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of ongoing management of a shaped online reputation, according to embodiments;

FIG. 2 illustrates an example of interactions between a reputation management service and an external resource to provide ongoing management of a shaped online reputation, according to embodiments;

FIG. 3 illustrates a component diagram of a reputation management service that provides ongoing management of a shaped online reputation, according to embodiments;

FIG. 4 illustrates an example of a user interface to provide ongoing management of a shaped online reputation, according to embodiments;

FIG. 5 is a simplified networked environment, where a system according to embodiments may be implemented;

FIG. 6 illustrates a general purpose computing device, which may be configured to provide ongoing management of a shaped online reputation, according to embodiments; and

FIG. 7 illustrates a logic flow diagram for a process to provide ongoing management of a shaped online reputation, according to embodiments.

### DETAILED DESCRIPTION

As briefly described above, a shaped online reputation may be managed continuously by a reputation management service. The reputation management service may monitor digital assets of a reputation owner hosted by external resources based on a reputation profile that is configured by a reputation manager. The reputation profile may include suggestions to shape an online reputation of the reputation owner. The digital assets may be owned by the reputation owner. Alternatively, third party content associated with the reputation owner may be identified as the digital assets. The digital assets may form the online reputation of the reputation owner.

A change to the digital assets may be detected. The change and the reputation profile may be processed to match suggested actions. The suggested actions may include operations to shape the online reputation of the reputation owner. The suggested actions may include a remove action, an add to action, and an update action, among others. A description of the suggested actions, the reputation profile, and the change may be transmitted to the reputation manager to prompt the reputation manager to customize or confirm the reputation profile and the suggested actions. In response to a confirmation of the reputation profile and the suggested action, the suggested actions may be executed to shape the online reputation.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, and a memory chip, among others. The computer-readable storage medium can for example be implemented via one or more of a volatile computer memory, a non-volatile memory, a hard drive, and a flash drive.

Throughout this specification, the term “platform” may be a combination of software and hardware components to provide ongoing management of a shaped online reputation. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

A computing device, as used herein, refers to a device comprising at least a memory and one or more processors that includes a server, a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

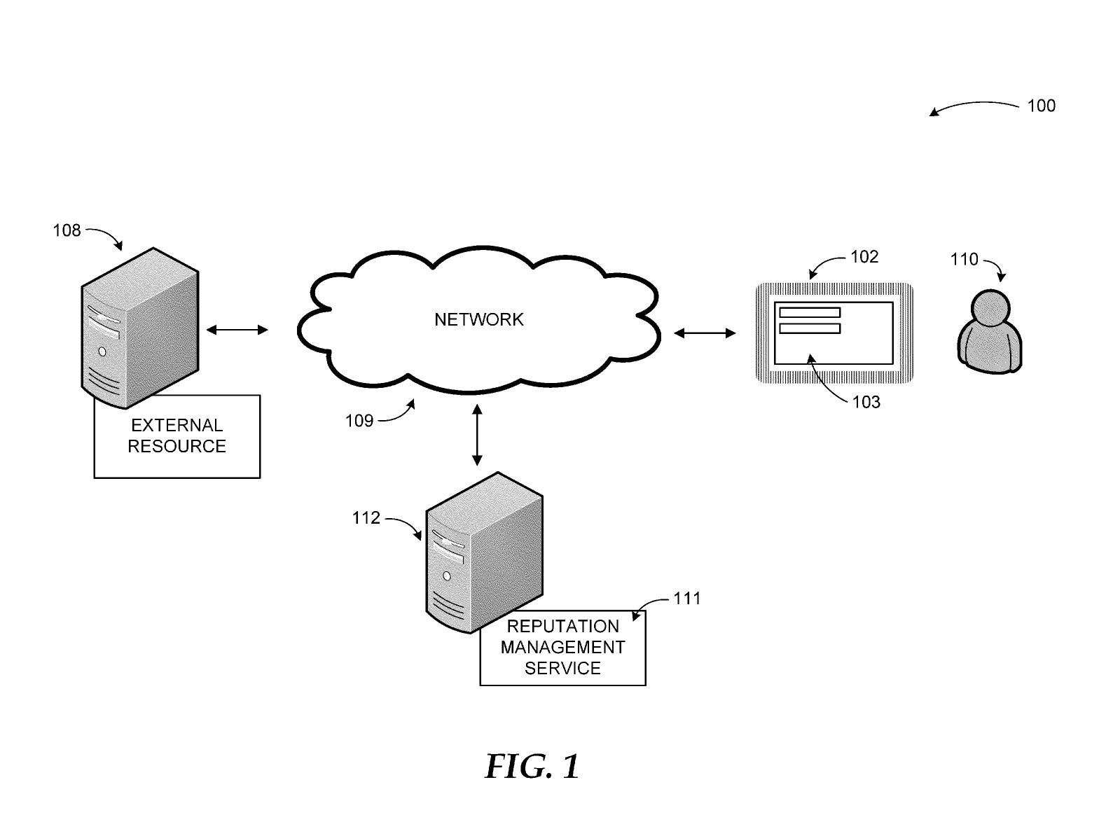

FIG. 1 is a conceptual diagram illustrating an example of ongoing management of a shaped online reputation, according to embodiments.

In a diagram 100, a computing device 112 may execute a reputation management service 111. An example of the reputation management service 111 may include an application that provides information and data processing functionality. The computing device 112 may include a hardware based server, a laptop computer, and a desktop computer, among others.

The computing device 112 may communicate with an external resource 108 and a client device 102 through a network 109. The external resource 108 may host digital assets associated with a reputation owner. An aggregation of digital assets associated with the reputation owner hosted by various external resources may form an online reputation of the reputation owner.

The external resource 108 may provide a variety of productivity services. Examples of a productivity service may include a communication service, a social networking service, a professional networking service, an application service, and a storage service, among others. The communication service may facilitate communication between callers. The storage service may host digital assets associated with reputation owners. The application service may provide applications for use and consumption by client devices.

The network 109 may include wired and wireless components that allow wired and wireless communication between nodes such as the external resource 108, the computing device 112, and the client device 102, among others. The client device 102 may display a client user interface (UI) 103 of the reputation management service 111 to a reputation manager 110. The client UI 103 may provide functionality to provide ongoing management of a shaped online reputation by allowing the reputation manager 110 to customize the reputation profile and suggested actions (that are guided by change to the digital assets), among other functionality.

The reputation manager 110 may be allowed to interact with the client UI 103 through an input device or touch enabled display component of the client device 102. The client device 102 may include a display device such as the touch enabled display component, and a monitor, among others. The display device may be used to provide the client UI 103 of the reputation management service 111 to the reputation manager 110. A change of the digital assets and the reputation profile may be processed to match suggested actions in response to a detection of the change. A description of the suggested actions, the reputation profile, and the change may be transmitted to the reputation manager 110 to prompt the reputation manager 110 to customize or confirm the reputation profile and the suggested actions. In response to a confirmation of the suggested actions, the suggested actions may be executed to shape the online reputation of the reputation owner.

The reputation manager 110 may interact with the client UI 103 with a keyboard based input, a mouse based input, a voice based input, a pen based input, and a gesture based input, among others. The gesture based input may include one or more touch based actions such as a touch action, a swipe action, and a combination of each, among others.

Digital assets such as pictures, documents, accounts, account information (such as account status information), among others hosted by the external resource 108 may be discovered as part of the online reputation of the reputation owner. The digital assets and a reputation profile may be matched to suggested actions with operations to shape the online reputation of the reputation owner. The digital assets, the reputation profile, and the suggested actions may be displayed to the reputation manager 110 on the client UI 103 of the reputation management service to prompt the reputation manager 110 to customize the reputation profile and the suggested actions.

While the example system in FIG. 1 has been described with specific components including the computing device 112, the reputation management service 111, embodiments are not limited to these components or system configurations and can be implemented with other system configuration employing fewer or additional components.

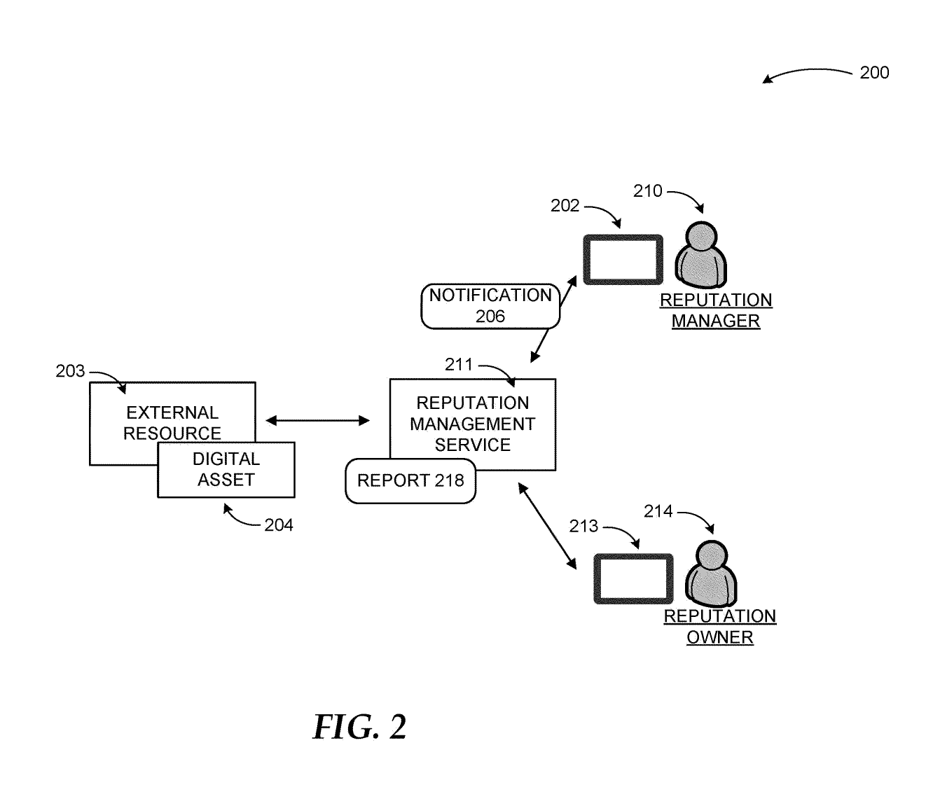

FIG. 2 illustrates an example of interactions between a reputation management service and an external resource to provide ongoing management of a shaped online reputation, according to embodiments.

In a diagram 200, a reputation management service 211 may interact with an external resource 203 to provide ongoing management of a shaped online reputation. Digital assets associated with a reputation owner hosted across various external resources may form an online reputation of the reputation owner. A digital asset 204 may include a document, an account, among others associated with a reputation owner 214. The digital asset 204 may be owned by the reputation owner 214. Alternatively, the digital asset 204 may be a third party content owned by a third party. The third party content may identify the reputation owner 214.

The reputation management service 211 may authenticate the reputation manager 210 through a client UI of the reputation management service 211 displayed on a client device 202. The reputation manager 210 may configure a reputation profile of the reputation owner 214. The reputation profile may include one or more reputation goals such as a request to remove negative publications associated with the reputation owner 214.

Credentials to an account of the reputation owner 214 may also be captured within the reputation profile. The reputation owner 214 may provide the credentials to a client UI of the reputation management service 211 displayed on a client device 213. The reputation manager 210 may be authorized to use the credentials to build the reputation profile. The reputation manager 210 may be authorized to view the credentials. Alternatively, the credentials of the reputation owner 214 may be hidden from the reputation manager 210 while allowing use of the credentials to build the reputation profile.

The reputation manager 210 may include the reputation owner 214, a legal representative of the reputation owner 214, an authorized family member of the reputation owner 214, an authorized relation of the reputation owner 214, an authorized colleague of the reputation owner 214, and an authorized supervisor of the reputation owner 214, among others. The reputation manager 210 may also be authorized to build a reputation profile for a legal relationship of the reputation owner 214. In an example scenario, a reputation manager 210 such as a parent may be allowed to build a reputation profile of a reputation owner such as a child. In another example scenario, the reputation manager 210 may include a supervisor of an employee identified as the reputation owner 214.

A change of the digital assets along with the reputation profile and suggested actions (that are matched to the change and the reputation profile) may be transmitted to the reputation manager 210 for a confirmation. The suggested actions may include operations to shape an online reputation of the reputation owner 214 such as a remove action, an add to action, or a modify action, among other actions to be applied to a digital asset. The suggested actions may be matched from a set of default reputation shaping actions based on matching attributes between the default actions and the suggestions within the reputation profile. The attributes may include a type, an identifier, or a timestamp, among other attributes associated with the digital assets.

The suggested actions, the change, the reputation profile may be displayed to the reputation manager 210 through the client UI of the reputation management service 211 on the client device 202. The client UI of the reputation management service 211 may display controls to customize or confirm the suggested actions and the reputation profile. Furthermore, in response to receiving the confirmation, the reputation management service 211 may execute the suggested actions to shape the online reputation of the reputation owner 214. A notification 206 may be transmitted to the reputation manager 210 to inform of a performance of the suggested actions.

Alternatively, a customization of the suggested actions may be received from the reputation manager 210. The customization of the suggested actions may be processed with a reputation shaping policy to detect conflicts with the policy. The reputation shaping policy may include rules to restrain the customization of the suggested actions. Example restraints may include rules to comply with document retention regulations of a jurisdiction.

The reputation management service 211 may either fail to detect conflicts or identify the conflicts. In case of confirming a failure to identify conflicts with the reputation shaping policy, the suggested actions with the customization may be executed to shape the online reputation of the reputation owner 214. The notification 206 may be transmitted to the reputation manager 210 to inform of a performance of the suggested actions with the customization.

In case of an identification of conflicts with the reputation shaping policy, the customization of the suggested actions and the reputation profile may be reprocessed to identify a new set of suggested actions that match the customization and the reputation profile. In response to identifying the new set of suggested actions, a report 218 that describes the conflicts and a new set of suggested actions, among other information may be transmitted to the reputation manager 210 to prompt the reputation manager 210 to confirm or customize the new set of suggested actions.

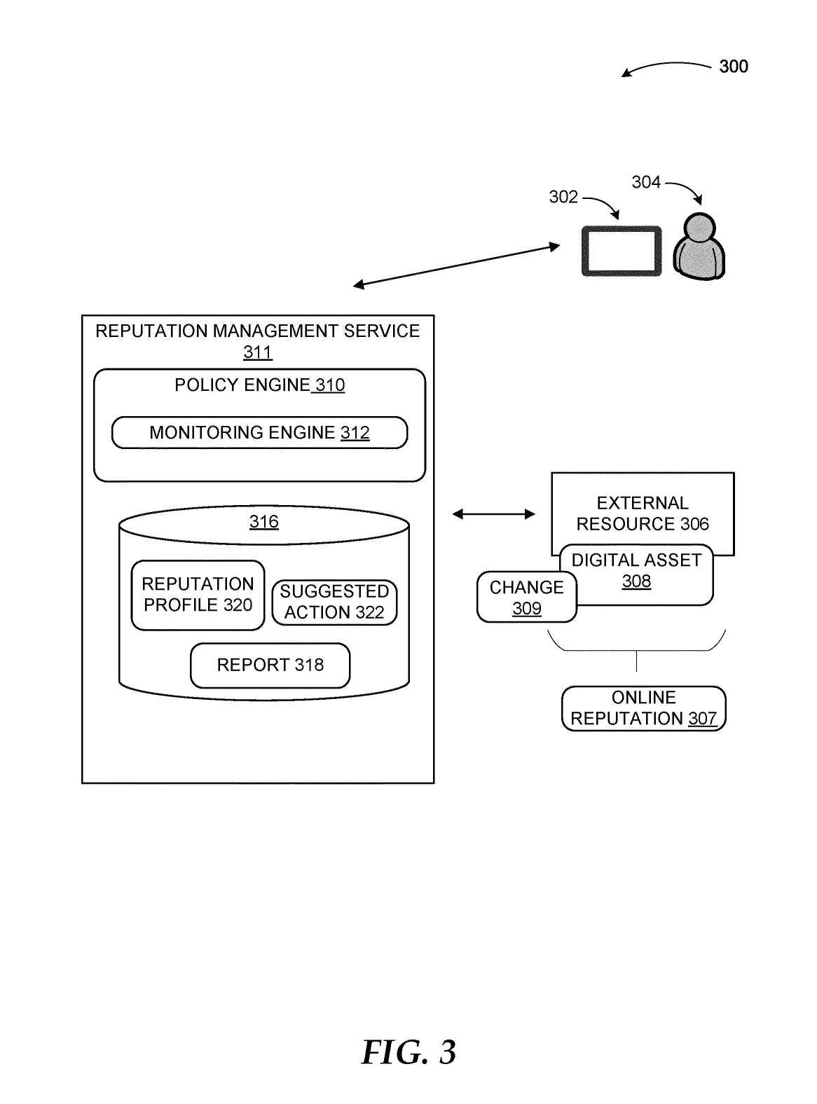

FIG. 3 illustrates a component diagram of a reputation management service that provides ongoing management of a shaped online reputation, according to embodiments.

In a diagram 300, a reputation management service 311 may interact with a reputation manager 304 through a client UI of the reputation management service 311 displayed on a client device 302. A monitoring engine 312 of the reputation management service 311 may monitor a digital asset 308 hosted by an external resource 306 and other digital assets that form an online reputation 307 of a reputation owner. The digital asset 308 may be owned by the reputation owner or may be a third party content (owned by a third party) that identifies the reputation owner.

The monitoring engine 312 may be a component of a policy engine 310 of the reputation management service 311. Alternatively, the monitoring engine 312 may be a stand-alone component of the reputation management service 311.

The policy engine 310 may detect a change 309 to the digital asset 308. The change 309 may include an update to the digital asset 308, a deletion of the digital asset 308, or an addition to the digital asset 308, among other modifications to the digital asset 308. The change 309 and the reputation profile 320 may be processed to match a suggested action 322. The suggested action 322 may include operations to shape the online reputation 307 of the reputation owner. A description of the suggested action 322, the reputation profile 320, and the change 309 may be transmitted to the reputation manager 304 to prompt the reputation manager 304 to confirm or customize the suggested action 322 and the reputation profile 320.

The policy engine 310 of the reputation management service 311 may generate a report on the online reputation 307. The report may include a history of previously executed suggested actions, a listing of updates to the digital assets, or a summary of updates to the reputation profile, among others. The report 318 may be transmitted to the reputation manager 304 through a client UI of the reputation management service 311 displayed on the client device 302.

The policy engine 310 may also analyze previously executed suggested actions and updates to the digital assets to generate a reputation change trend dataset. The report 318 may be generated with the reputation change trend dataset that may highlight changes to the online reputation 307 as a result of the previously executed suggested actions. The reputation change trend dataset may be transmitted to the reputation manager 304 within the report 318.

In an example scenario, report options may be transmitted to a client device 302 to be displayed on a client UI of the reputation management service 311. Selected report options may be received from the reputation manager 304. The selections may include a time range, a selection of the previously executed suggested actions, or a selection of the updates on the digital assets, among others. The report 318 may be generated based on the selections. The report may be transmitted to the reputation manager 304.

In another example scenario, a reputation progress dataset may be generated by comparing the reputation profile 320 and updates to the digital asset 308. An execution of the suggested action 322 may result in the updates to the digital asset 308. The report 318 may be generated from the reputation progress dataset in response to selections of report option (by the reputation manager 304) displayed on the client UI of the reputation management service 311. The report 318 may be transmitted to the reputation manager 304 to inform the reputation manager 304 of trends associated with changes to the online reputation 307.

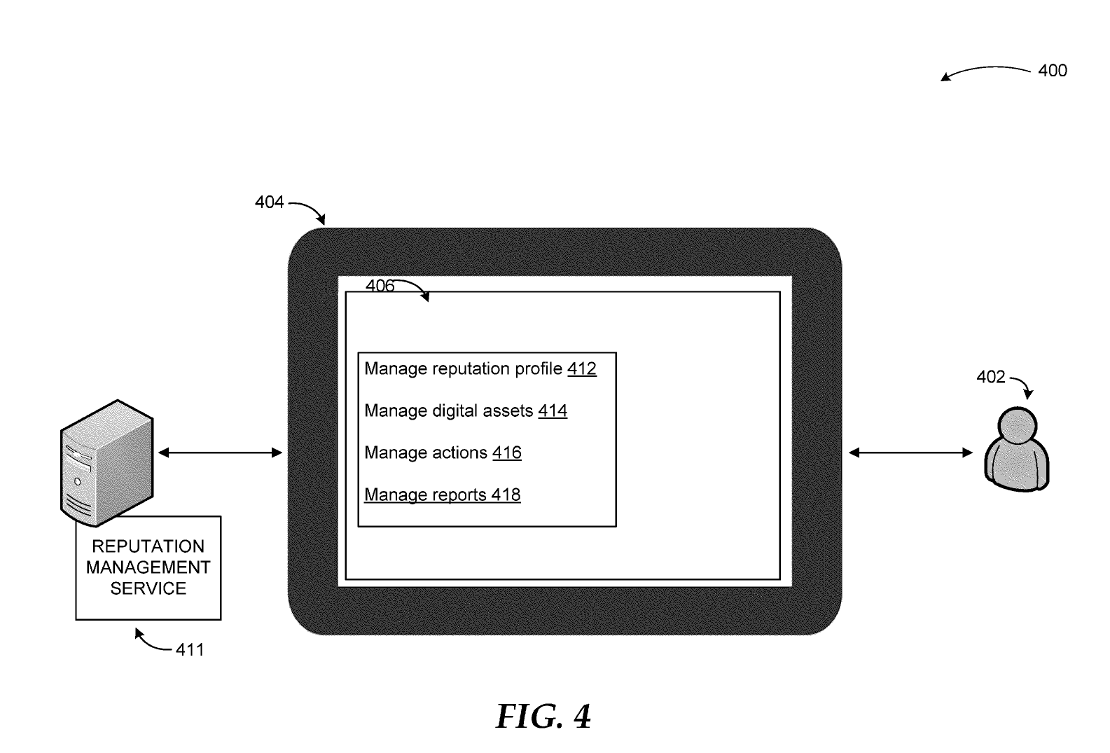

FIG. 4 illustrates an example of a user interface to provide ongoing management of a shaped online reputation, according to embodiments.

In a diagram 400, a reputation management service 411 may provide a client UI 406 on a computing device 404 to allow a reputation manager 402 to review and verify a suggested action, a selection of a digital asset, a reputation profile to shape an online reputation, and a report on the shaped online reputation.

The client UI 406 may display a “manage reputation profile” control 412 to provide the reputation manager 402 with additional controls to modify a reputation profile of the reputation owner. The reputation manager 402 may be provided with the additional controls to modify a reputation goal to shape the online reputation and credentials associated with accounts of the reputation owner that host the digital assets.

The client UI 406 may display a “manage digital assets” control 414 to provide the reputation manager 402 with additional controls to select from a list of digital assets associated with the reputation owner. The reputation manager 402 may be provided with the additional controls to select a subset of the digital assets to shape an online reputation of a reputation owner.

The client UI 406 may display a “manage actions” control 416 (upon activation) to provide additional controls to select and modify suggested actions that include operations to shape online reputation of the reputation owner because of a change to digital assets. An example may include a list of suggested actions such as an add to action, a delete action, or a modify action, among others. The reputation manager 402 may be provided with controls to select and modify the suggested actions from the list.

The client UI 406 may display a “manage reports” control 418 (upon activation) to provide additional controls to select and modify attributes associated with a report on continuous shaping of the online reputation of the reputation owner. An example may include report options to select datasets such as previously executed suggested actions, and updates to the digital assets, among others.

According to embodiments described herein, the technical advantage of ongoing management of a shaped online reputation may include improved usability of online reputation with optimized actions generated to monitor and manage digital assets associated with the online reputation. A reputation profile, optimized actions to shape the online reputation, and reports on the online reputation may address a need that arises from extensive digital personalities generated by reputation owners in an extensive digital world. The reputation profile, the optimized actions, and the reputation reports may streamline ongoing management of the shaped online reputation compared to cumbersome legacy manual reputation review solutions.

Embodiments address a need that arises from very large scale of operations created by networked computing and cloud based services that cannot be managed by humans. The actions/operations described herein are not a mere use of a computer, but address results of a system that is a direct consequence of software used as a service such as reputation management services offered in conjunction with shaping of an online reputation of a reputation owner.

The example scenarios and schemas in FIG. 1 through 4 are shown with specific components, data types, and configurations. Embodiments are not limited to systems according to these example configurations. Ongoing management of a shaped online reputation may be implemented in configurations employing fewer or additional components in applications and user interfaces. Furthermore, the example schema and components shown in FIG. 1 through 4 and their subcomponents may be implemented in a similar manner with other values using the principles described herein.

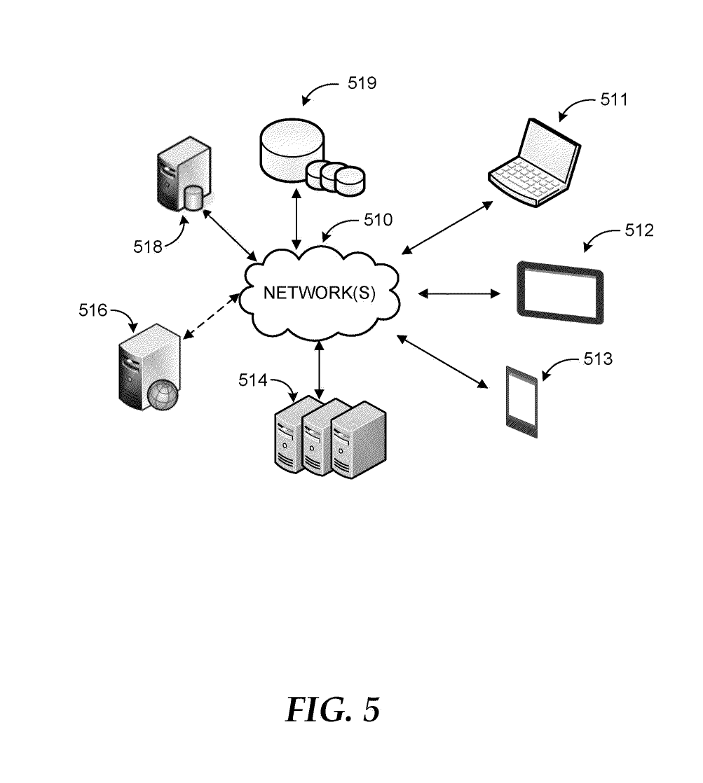

FIG. 5 is an example networked environment, where embodiments may be implemented. A reputation management service configured to provide ongoing management of a shaped online reputation may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A reputation management service may monitor digital assets of a reputation owner hosted by external resources based on a reputation profile configured by a reputation manager. A change to the digital assets and the reputation profile may be processed to match suggested actions in response to a detection of the change. A description of the suggested actions, the reputation profile, and the change may be transmitted to the reputation manager to prompt the reputation manager to customize or confirm the reputation profile and the suggested actions. The suggested actions may be executed to shape the online reputation in response to a confirmation of the transmission by the reputation manager. The reputation management service may store data associated with digital asset in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide ongoing management of a shaped online reputation. Furthermore, the networked environments discussed in FIG. 5 are for illustration purposes only. Embodiments are not limited to the example applications, modules, or processes.

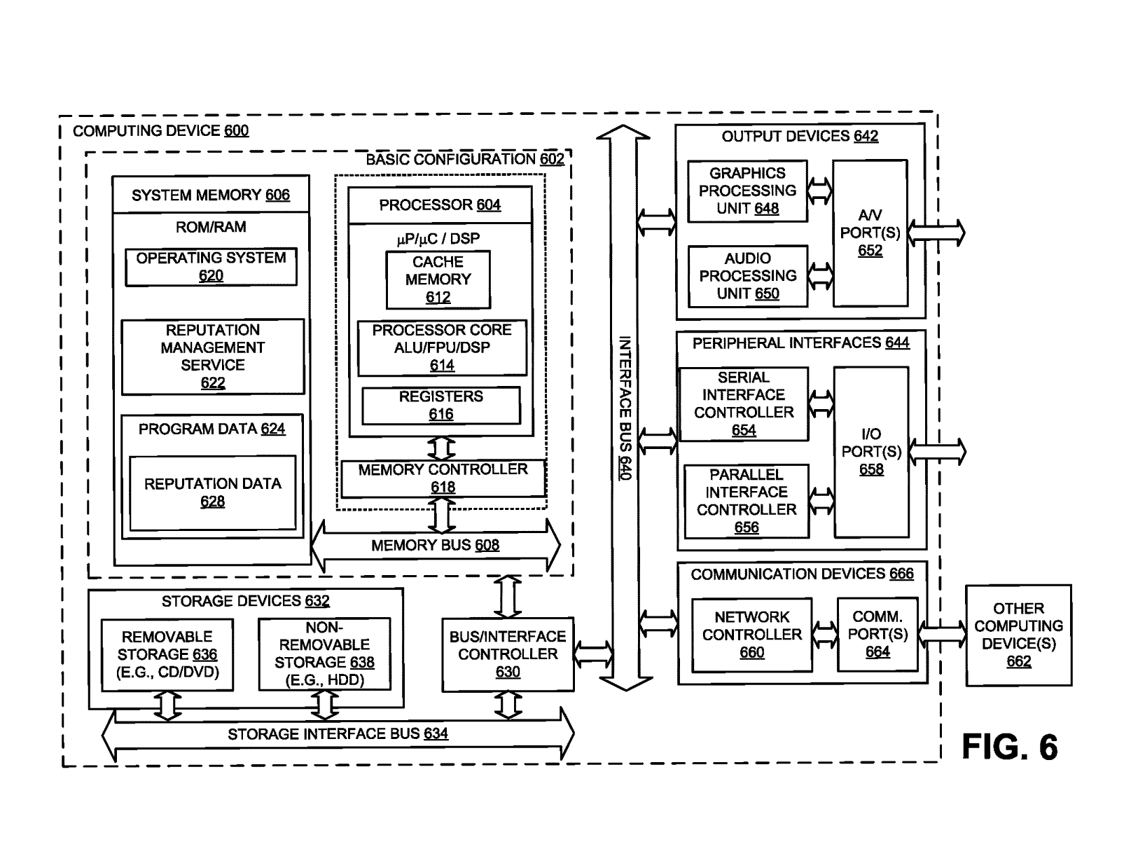

FIG. 6 illustrates a general purpose computing device, which may be configured to provide ongoing management of a shaped online reputation, arranged in accordance with at least some embodiments described herein.

For example, the computing device 600 may be used to provide ongoing management of a shaped online reputation. In an example of a basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including, but not limited to, a microprocessor (μP), a microcontroller (μC), a digital signal processor (DSP), or any combination thereof. The processor 604 may include one more levels of caching, such as a level cache memory 612, a processor core 614, and registers 616. The processor core 614 may include an arithmetic logic unit (ALU), a floating point unit (FPU), a digital signal processing core (DSP Core), or any combination thereof. A memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a reputation management service 622, and a program data 624. The reputation management service 622 may monitor digital assets of a reputation owner hosted by external resources based on a reputation profile configured by a reputation manager. A change to the digital assets and the reputation profile may be processed to match suggested actions in response to a detection of the change. A description of the suggested actions, the reputation profile, and the change may be transmitted to the reputation manager to prompt the reputation manager to customize or confirm the reputation profile and the suggested actions. The suggested actions may be executed to shape the online reputation in response to a confirmation of the transmission by the reputation manager. Components of the reputation management service 622 (such as a client user interface) may also be displayed on a display device. An example of the display device may include another computing device with a display component. The display device may include a touch based device that detects gestures such as a touch action. The display device may also provide feedback in response to detected gestures (or any other form of input) by transforming a client user interface of the reputation management service 622, displayed by the touch based device. The program data 624 may also include, among other data, reputation data 628, or the like, as described herein. The reputation data 628 may include a reputation profile, a digital asset, a suggested action, a report, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636, and the non-removable storage devices 638 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 may include a graphics processing unit 648 and an audio processing unit 650, which may be configured to communicate to various external devices, such as a display or speakers via one or more A/V ports 652. One or more example peripheral interfaces 644 may include a serial interface controller 654 or a parallel interface controller 656, which may be configured to communicate with external devices, such as input devices (for example, keyboard, mouse, pen, voice input device, touch input device, etc.) or other peripheral devices (for example, printer, scanner, etc.) via one or more I/O ports 658. An example communication device 666 may include a network controller 660, which may be arranged to facilitate communications with one or more other computing devices 662 over a network communication link via one or more communication ports 664. The one or more other computing devices 662 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide ongoing management of a shaped online reputation. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

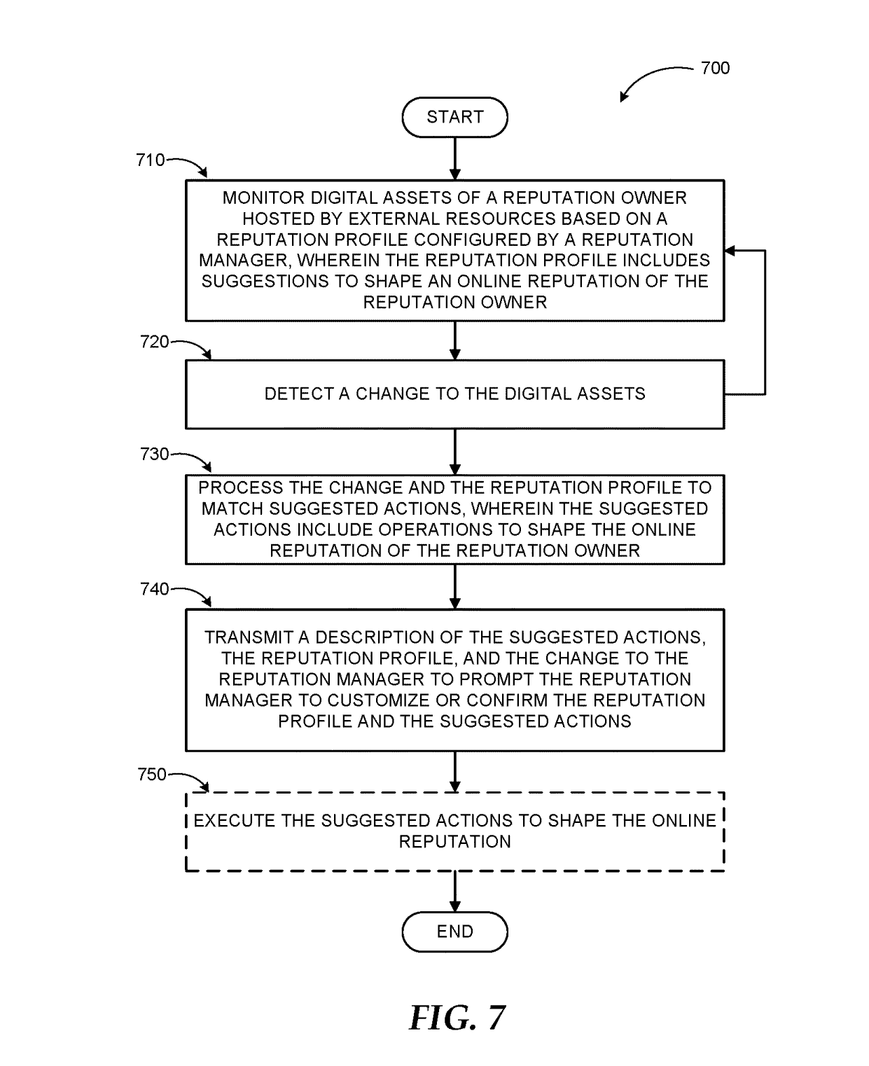

FIG. 7 illustrates a logic flow diagram for a process to provide an ongoing management of a shaped online reputation, according to embodiments. Process 700 may be implemented on a reputation management service.

Process 700 begins with operation 710, where digital assets of a reputation owner hosted by external resources may be monitored based on a reputation profile configured by a reputation manager. The reputation profile may include suggestions to shape an online reputation of the reputation owner. A change to the digital assets may be detected at operation 720. In response, at operation 730, the change and the reputation profile may be processed to match suggested actions. The suggested actions may include operations to shape the online reputation of the reputation owner.

A description of the suggested actions, the reputation profile, and the change may be transmitted to the reputation manager to prompt the reputation manager to customize or confirm the reputation profile and the suggested actions at operation 740. In response to a confirmation of the suggested actions, the suggested actions may be executed to shape the online reputation at operation 750.

Some or all of the operations of the process 700 may be reprocessed with feedback operations. In an example scenario, the change to the digital assets detected in the operation 720 may be used as an input in the operation 710 to monitor related digital assets. The related digital assets may include the change. Other feedback loops may be used with other operations of the process 700 to customize operations of the process 700, among other things.

The operations included in process 700 are for illustration purposes. A reputation management service according to embodiments may be implemented by similar processes with fewer or additional steps, as well as in different order of operations using the principles described herein.

According to some examples a computing device to provide ongoing management of an online reputation may be described. The computing device may include a memory configured to store instructions associated with a management service and one or more processors coupled to the memory. The one or more processors may execute the management service in conjunction with instructions stored in the memory. The management service may include a monitoring engine configured to monitor digital assets of a reputation owner hosted by external resources based on a reputation profile configured by a reputation manager, where the reputation profile includes suggestions to shape an online reputation of the reputation owner. The management service may also include a policy engine configured to detect a change to the digital assets, process the change and the reputation profile to match suggested actions, where the suggested actions include operations to shape the online reputation of the reputation owner, and transmit a description of the suggested actions, the reputation profile, and the change to the reputation manager to prompt the reputation manager to customize the reputation profile and the suggested actions.

According to other examples, the policy engine is further configured to receive a confirmation of the reputation profile and the suggested actions from the reputation manager, execute the suggested actions to shape the online reputation of the reputation owner, and transmit a notification to inform the reputation manager of a performance of the suggested actions. The policy engine is further configured to receive a customization of the suggested actions from the reputation manager and process the customization of the suggested actions with a reputation shaping policy to detect one or more conflicts with the reputation shaping policy, where the reputation shaping policy identifies one or more rules to restrain the customization of the suggested actions. The policy engine is further configured to confirm the customization with a failure to detect the one or more conflicts with the reputation shaping policy, execute the suggested actions with the customization to shape the online reputation of the reputation owner, and transmit a notification to inform the reputation manager of a performance of the suggested actions with the customization. The policy engine is further configured to identify the one or more conflicts with the reputation shaping policy, reprocess the customization of the suggested actions and the reputation profile to identify a new set of the suggested actions, in response to an identification of the new set of the suggested actions, transmit a report of the one or more conflicts and the new set of suggested action to the reputation manager to prompt the reputation manager to one or more of customize and confirm the new set of suggested action.

According to further examples, the reputation manager may include one or more of the reputation owner, a legal representative of the reputation owner, an authorized family member of the reputation owner, an authorized relation of the reputation owner, an authorized colleague of the reputation owner, and an authorized supervisor of the reputation owner. The policy engine is further configured to generate a report on the online reputation and transmit the report to the reputation manager. The report may include one or more of a history of previously executed suggested actions, a listing of updates to the digital assets, and a summary of updates to the reputation profile. The policy engine is further configured to analyze previously executed suggested actions and updates to the digital assets to generate a reputation change trend dataset and generate the report with the reputation change trend dataset. The policy engine is further configured to identify a subset of default reputation shaping actions that match the suggestions of the reputation profile as the suggested actions based on attributes of the default reputation shaping actions. The attributes may include a type, an identifier, and a timestamp associated with the digital assets.

According to some examples, a method executed on a computing device to provide ongoing management of an online reputation may be described. The method may include monitoring digital assets of a reputation owner at external resources based on a reputation profile configured by a reputation manager, where the reputation profile includes suggestions to shape an online reputation of the reputation owner, detecting a change to the digital assets, processing the change and the reputation profile to match suggested actions, where the suggested actions include operations to shape the online reputation of the reputation owner, transmitting a description of the suggested actions, the reputation profile, and the change to the reputation manager to prompt the reputation manager to one or more of customize and confirm the reputation profile and the suggested actions, and in response to a confirmation of the reputation profile and the suggested actions received from the reputation manager, executing the suggested actions to shape the reputation profile of the reputation owner.

According to other examples, the method may further include transmitting report options to the reputation manager to allow the reputation manager to generate a report on the online reputation, receiving one or more selections of the report options from the reputation manager, where the one or more selections includes one or more of a time range of previously executed suggested actions, a subset of the previously executed suggested actions, and a subset of updates to the digital assets, generating the report on the previously executed suggested actions and updates to the digital assets based on the one or more selections of the report options, and transmitting the report to the reputation manager. The method may further include detecting one or more updates to the digital assets based on an execution of the suggested actions, generating a reputation progress dataset by comparing the reputation profile to the digital assets and the one or more updates, transmitting report options to the reputation manager to allow the reputation manager to generate a report on the online reputation based on the reputation progress dataset, and generating the report from the reputation progress dataset based on selections of the report options received from the reputation manager. The method may further include transmitting a confirmation of an execution of the suggested actions and a report that include updates to the digital assets and a summary of the suggested actions to the reputation manager.

According to some examples, a computer-readable memory device with instructions stored thereon to provide ongoing management of an online reputation may be described. The instructions may include actions that are similar to the method described above.

According to some examples a means to provide ongoing management of an online reputation may be described. The means to provide ongoing management of an online reputation may include a means to monitor digital assets of a reputation owner hosted by external resources based on a reputation profile configured by a reputation manager, where the reputation profile includes suggestions to shape an online reputation of the reputation owner, a means to detect a change to the digital assets, a means to process the change and the reputation profile to match suggested actions, where the suggested actions include operations to shape the online reputation of the reputation owner, and a means to transmit a description of the suggested actions, the reputation profile, and the change to the reputation manager to prompt the reputation manager to customize the reputation profile and the suggested actions.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide ongoing management of an online reputation, the computing device comprising:
a memory configured to store instructions associated with a reputation management service;
one or more processors coupled to the memory, the one or more processors executing the management service in conjunction with the instructions stored in the memory, wherein the reputation management service includes:
a monitoring engine configured to:
monitor digital assets of a reputation owner hosted by external resources based on a reputation profile configured by a reputation manager, wherein the reputation profile includes suggestions to shape an online reputation of the reputation owner;
a policy engine configure to:
detect a change to the digital assets;
process the change and the reputation profile to match suggested actions, wherein the suggested actions include operations to shape the online reputation of the reputation owner; and
transmit a description of the suggested actions, the reputation profile, and the change to the reputation manager to prompt the reputation manager to customize the reputation profile and the suggested actions.

2. The computing device of claim 1, wherein the policy engine is further configured to:
receive a confirmation of the reputation profile and the suggested actions from the reputation manager;
execute the suggested actions to shape the online reputation of the reputation owner; and
transmit a notification to inform the reputation manager of a performance of the suggested actions.

3. The computing device of claim 1, wherein the policy engine is further configured to:
receive a customization of the suggested actions from the reputation manager; and
process the customization of the suggested actions with a reputation shaping policy to detect one or more conflicts with the reputation shaping policy, wherein the reputation shaping policy identifies one or more rules to restrain the customization of the suggested actions.

4. The computing device of claim 3, wherein the policy engine is further configured to:
confirm the customization with a failure to detect the one or more conflicts with the reputation shaping policy;
execute the suggested actions with the customization to shape the online reputation of the reputation owner; and
transmit a notification to inform the reputation manager of a performance of the suggested actions with the customization.

5. The computing device of claim 3, wherein the policy engine is further configured to:
identify the one or more conflicts with the reputation shaping policy;
reprocess the customization of the suggested actions and the reputation profile to identify a new set of the suggested actions; and
in response to an identification of the new set of the suggested actions, transmit a report of the one or more conflicts and the new set of suggested action to the reputation manager to prompt the reputation manager to one or more of customize and confirm the new set of suggested action.

6. The computing device of claim 1, wherein the reputation manager includes one or more of the reputation owner, a legal representative of the reputation owner, an authorized family member of the reputation owner, an authorized relation of the reputation owner, an authorized colleague of the reputation owner, and an authorized supervisor of the reputation owner.

7. The computing device of claim 1, wherein the policy engine is further configured to:
generate a report on the online reputation; and
transmit the report to the reputation manager.

8. The computing device of claim 7, wherein the report includes one or more of a history of previously executed suggested actions, a listing of updates to the digital assets, and a summary of updates to the reputation profile.

9. The computing device of claim 7, wherein the policy engine is further configured to:
analyze previously executed suggested actions and updates to the digital assets to generate a reputation change trend dataset; and
generate the report with the reputation change trend dataset.

10. The computing device of claim 1, wherein the policy engine is further configured to:
identify a subset of default reputation shaping actions that match the suggestions of the reputation profile as the suggested actions based on attributes of the default reputation shaping actions.

11. The computing device of claim 10, wherein the attributes include a type, an identifier, and a timestamp associated with the digital assets.

12. A method executed on a computing device to provide ongoing management of an online reputation, the method comprising:
monitoring digital assets of a reputation owner at external resources based on a reputation profile configured by a reputation manager, wherein the reputation profile includes suggestions to shape an online reputation of the reputation owner;
detecting a change to the digital assets;
processing the change and the reputation profile to match suggested actions, wherein the suggested actions include operations to shape the online reputation of the reputation owner;
transmitting a description of the suggested actions, the reputation profile, and the change to the reputation manager to prompt the reputation manager to one or more of customize and confirm the reputation profile and the suggested actions; and
in response to a confirmation of the reputation profile and the suggested actions received from the reputation manager, executing the suggested actions to shape the reputation profile of the reputation owner.

13. The method of claim 12, further comprising:
transmitting report options to the reputation manager to allow the reputation manager to generate a report on the online reputation; and
receiving one or more selections of the report options from the reputation manager, wherein the one or more selections includes one or more of a time range of previously executed suggested actions, a subset of the previously executed suggested actions, and a subset of updates to the digital assets.

14. The method of claim 13, further comprising:
generating the report on the previously executed suggested actions and updates to the digital assets based on the one or more selections of the report options; and
transmitting the report to the reputation manager.

15. The method of claim 12, further comprising:
detecting one or more updates to the digital assets based on an execution of the suggested actions; and
generating a reputation progress dataset by comparing the reputation profile to the digital assets and the one or more updates.

16. The method of claim 15, further comprising:
transmitting report options to the reputation manager to allow the reputation manager to generate a report on the online reputation based on the reputation progress dataset; and
generating the report from the reputation progress dataset based on selections of the report options received from the reputation manager.

17. The method of claim 12, further comprising:
transmitting a confirmation of an execution of the suggested actions and a report that include updates to the digital assets and a summary of the suggested actions to the reputation manager.

18. A computer-readable memory device with instructions stored thereon to provide ongoing management of an online reputation, the instructions comprising:
monitoring digital assets of a reputation owner at external resources based on a reputation profile configured by a reputation manager, wherein the reputation profile includes suggestions to shape an online reputation of the reputation owner;
detecting a change to the digital assets;
processing the change and the reputation profile to match suggested actions, wherein the suggested actions include operations to shape the online reputation of the reputation owner;
transmitting a description of the suggested actions, the reputation profile, and the change to the reputation manager to prompt the reputation manager to one or more of customize and confirm the reputation profile and the suggested actions; and
in response to a confirmation of the reputation profile and the suggested actions received from the reputation manager, executing the suggested actions to shape the online reputation of the reputation owner.

19. The computer-readable memory device of claim 18, wherein the instructions further comprise:
receiving a customization of the suggested actions from the reputation manager;
processing the customization of the suggested actions with a reputation shaping policy to detect one or more conflicts with the reputation shaping policy, wherein the reputation shaping policy identifies one or more rules to restrain the customization of the suggested actions;
confirming the customization with a failure to identify the one or more conflicts with the reputation shaping policy;
executing the suggested actions with the customization to shape the online reputation of the reputation owner; and
transmitting a notification to inform the reputation manager of a performance of the suggested actions with the customization.

20. The computer-readable memory device of claim 18, wherein the instructions further comprise:
transmitting report options to the reputation manager to allow the reputation manager to generate a report on the online reputation;
receiving one or more selections of the report options from the reputation manager, wherein the one or more selections includes one or more of a time range of previously executed suggested actions, a subset of the previously executed suggested actions, and a subset of updates to the digital assets;
generating the report on the previously executed suggested actions and updates to the digital assets based on the one or more selections of the report options; and
transmitting the report to the reputation manager.
